(19) United States
(12) Patent Application Publication
(10) Pub. No.: US 2023/0289415 A1
(43) Pub. Date: Sep. 14, 2023

(54) FINGERPRINT CARD IMPLEMENTATION METHOD AND FINGERPRINT CARD

(71) Applicant: FEITIAN TECHNOLOGIES CO., LTD., Beijing (CN)

(72) Inventors: Zhou Lu, Beijing (CN); Huazhang Yu, Beijing (CN)

(21) Appl. No.: 17/909,434

(22) PCT Filed: Sep. 10, 2021
(86) PCT No.: PCT/CN2021/117577

§ 371 Date: Sep. 5, 2022

(30) Foreign Application Priority Data
Nov. 26, 2020 (CN) 202011342326.4

(51) Int. Cl. G06F 21/32; G06F 21/74

(52) U.S. Cl. CPC G06F 21/32; G06F 21/74

(57) ABSTRACT

A fingerprint card implementation method, comprising: a card receiving an instruction sent by a terminal and determining the type of the instruction, and when the instruction is a third instruction containing data of a processing option data object list, the card returning, according to the value of its own application controller attribute and a fingerprint verification result, a response to the third instruction of a default type or a response to the third instruction of a fingerprint type. By means of the method, fingerprint verification is added during the process of using a card, and there is no need to input a password or signature after the fingerprint verification is passed, thereby solving the problem of it not being possible to use the card as the password is forgotten.

### FIELD OF THE INVENTION

The present invention is related to a method for realizing a fingerprint card and the fingerprint card itself, which belongs to communication technology field.

### PRIOR ART

At present, when performing business communication by using an IC card, verifying identity of a card holder is performed according to application controller returned by the IC card, for example, verifying PIN code usually. When a PIN code is inputting by the card holder, the PIN code is easily to be leaked because of peeping at PIN code or the PIN code is intercepted by a terminal, therefore security risk of information of card holder is coming up. In addition, when a card holder has many IC cards, the card cannot be used normally because the card holder forgets PIN code or mistaken memory of the card holder.

### SUMMARY OF THE INVENTION

The object of the present invention is to provide a method for realizing fingerprint card and a fingerprint card, which can enhance security of the fingerprint card. In a process of using the card, a verifying fingerprint is added and, inputting a password or a signature is no longer needed after the verifying fingerprint successfully, which solves such a problem that a card cannot be used due to forgetting password.

Therefore, according to one aspect of the present invention, there is provided a method for realizing fingerprint card, which comprises the following steps:
Step 1, receiving, by a card, an instruction sent by a terminal, and determining type of the instruction; when the instruction is a third instruction comprising Processing Options Data Object List data, executing Step 2;
Step 2, determining, by the card, value of application controller attribution of the card,
when the value of the application controller attribution of the card is a first preset value, verifying, by the card, fingerprint of a user, obtaining a result of fingerprint verifying and determining whether the result of fingerprint verifying is that fingerprint verifying is successful, if yes, executing Step 3, if no, setting, by the card, a business refusing flag, executing Step 4;
when the value of the application controller attribution is a second preset value, verifying, by the card, fingerprint of the user, obtaining a fingerprint verifying result and determining whether the fingerprint verifying result is that fingerprint verifying is successful, if yes, executing Step 3; otherwise, executing Step 4; and
when value of the application controller attribution is a third preset value, determining, by the card, whether type of the terminal is a specified terminal type, if yes, executing Step 4; if no, verifying, by the card, fingerprint of the user, obtaining a fingerprint verifying result and determining whether the fingerprint verifying result is that fingerprint verifying is successful, if yes, executing Step 3, if no, setting, by the card, a business refusing flag, then executing Step 4;
Step 3, determining, by the card, whether business type in the Processing Options Data Object List data is specified type of business, if yes, executing Step 4; if no, executing Step 5;
Step 4, returning, by the card, a third instruction response of default type comprising a first Application Interchange Profile and a first application file locator to the terminal;
Step 5, returning, by the card, a third instruction response of fingerprint type comprising a second Application Interchange Profile and a second application file locator to the terminal;
when the instruction is a fourth instruction generated according to a first application file locator, returning, by the card, a read record specified by the first application file locator to the terminal; and
when the instruction is a fourth instruction generated according to a second application file locator, returning, by the card, a read record specified by the second application file locator to the terminal.

According to another aspect of the present invention, there is provided a fingerprint card, which comprises:
a receiving module configured to receive an instruction sent from a terminal;
a first determining module configured to determine type of the instruction received by the receiving module;
a second determining module configured to determine value of application controller attribution of the card when the first determining module determines that type of the instruction; when the instruction is a third instruction comprising Processing Options Data Object List data;
a verifying and obtaining and determining module configured to verify fingerprint of a user, obtain a fingerprint verifying result and determine whether the fingerprint verifying result is that fingerprint verifying is successful when the second determining module determines that the value of application controller attribution of the card is a first preset value;
the verifying and obtaining and determining module further configured to verify fingerprint of a user, obtain a fingerprint verifying result and determine whether the fingerprint verifying result is that fingerprint verifying is successful when the second determining module determines that the value of application controller attribution of the card is a second preset value;
the verifying and obtaining and determining module further configured to verify fingerprint of a user, obtain a fingerprint verifying result and determine whether the fingerprint verifying result is that fingerprint verifying is successful when a third determining module determines that type of the terminal is a specified terminal type;
the third determining module configured to determine whether type of the terminal is a specified terminal type when the second determining module determines that the value of the application controller attribution is a third preset value;
a setting module configured to set business refusing flag when the second determining module determines that the value of the application controller attribution is the first preset value and the verifying and obtaining and determining module determines that the fingerprint verifying result is not that fingerprint verifying is successful;
the setting module further configured to set business refusing flag when the third determining module determines that the type of the terminal is not a specified terminal type and the verifying and obtaining and determining module determines that the fingerprint verifying result is not that fingerprint verifying is successful;
a fourth determining module configured to determine whether business type in the Processing Options Data Object List data is specified type of business when the verifying and obtaining and determining module determines that the fingerprint verifying result is that fingerprint verifying is successful;
a first returning module configured to, after the setting module sets the business refusing flag, return a third instruction response of default type comprising a first Application Interchange Profile and a first application file locator to the terminal;
the first returning module further configured to, when the fourth determining module determines that business type in the Processing Options Data Object List data is a specified type of business, return a third instruction response of fingerprint type comprising a second Application Interchange Profile and a second application file locator to the terminal;
the first returning module further configured to return a third instruction response of default type comprising a first Application Interchange Profile and a first application file locator to the terminal when the second determining module determines that the value of application controller attribution of the card is a second preset value and the verifying and obtaining and determining module determines that the fingerprint verifying result is not that fingerprint verifying is successful;
the first returning module further configured to return a reading record specified by the first application file locator to the terminal when the first determining module determines that the type of the instruction is a fourth instruction generated according to a first application file locator, and
a second returning module configured to return a third instruction response of fingerprint type comprising a second Application Interchange Profile and a second application file locator to the terminal when the fourth determining module determines that the business type in the Processing Options Data Object List data is not specified business type; further configured to return a reading record specified by the second application file locator to the terminal when the first determining module determines that the type of the instruction is a fourth instruction generated according to the second application file locator.

According to the present invention, a fingerprint identifying module is added to the IC card, and fingerprint verifying is added during a process of using the card, inputting an online PIN code or a signature is no longer needed after the fingerprint is verified successfully. In this way, any PIN code is not leaked easily, and any problem that card cannot be used due to forgetting password is avoided.

### BRIEF DESCRIPTION OF DRAWINGS

FIG. 1 is a flow chart for realizing a fingerprint card provided by Embodiment 1 of the present invention;

FIG. 2 is a flow chart for realizing a fingerprint card provided by Embodiment 2 of the present invention; and

FIG. 3 is a block diagram of a fingerprint card provided by Embodiment 3 of the present invention.

### DESCRIPTION OF EMBODIMENTS

In the following, clear and complete description will be made on technical solutions in embodiments of the present disclosure in connection with the drawings of the embodiments of the present disclosure. Obviously, the described embodiments are only part of embodiments of the present disclosure, but not all the embodiments. All other embodiments obtained by those skilled in the art based on the embodiments in the present disclosure without creative work fall in the protection scope of the present disclosure.

### Embodiment 1

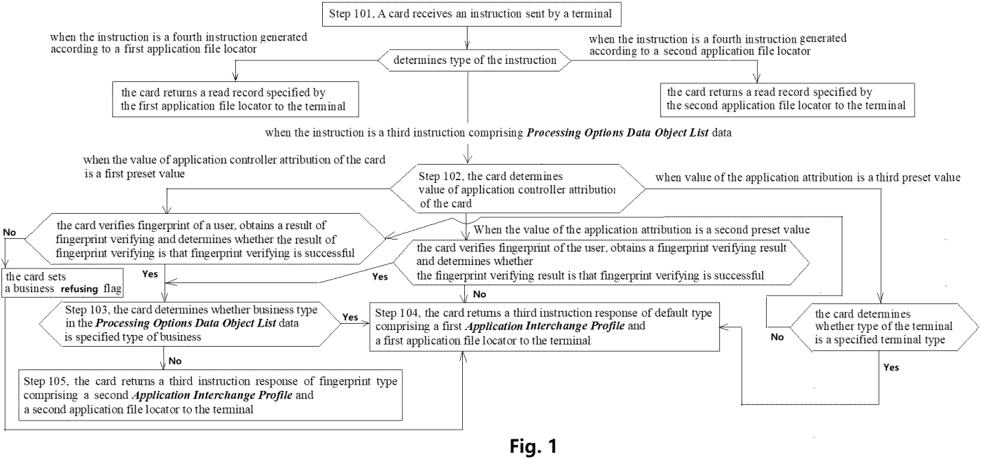

Embodiment 1 provides a method for realizing a fingerprint card. As shown in FIG. 1, the method specifically includes:
Step 101, A card receives an instruction sent by a terminal and determines type of the instruction, when the instruction is a third instruction comprising Processing Options Data Object List data, executing Step 102;
Step 102, the card determines value of application controller attribution of the card;
when the value of application controller attribution of the card is a first preset value, the card verifies fingerprint of a user, obtains a result of fingerprint verifying and determines whether the result of fingerprint verifying is that fingerprint verifying is successful, if yes, executes Step 103, if no, the card sets a business refusing flag, then executes Step 104;
when the value of the application controller attribution is a second preset value, the card verifies fingerprint of the user, obtains a fingerprint verifying result and determines whether the fingerprint verifying result is that fingerprint verifying is successful, if yes, executing Step 103; otherwise, executing Step 104;
when the value of the application controller attribution is a third preset value, the card determines whether type of the terminal is a specified terminal type, if yes, executing Step 104; if no, the card verifies fingerprint of the user, obtains a fingerprint verifying result and determines whether the fingerprint verifying result is that fingerprint verifying is successful, if yes, executing Step 103, if no, setting, by the card, a business refusing flag, then executing Step 104;
Step 103, the card determines whether business type in the Processing Options Data Object List data is specified type of business, if yes, executing Step 104; if no, executing Step 105;
Step 104, the card returns a third instruction response of default type comprising a first Application Interchange Profile and a first application file locator to the terminal;
Step 105, the card returns a third instruction response of fingerprint type comprising a second Application Interchange Profile and a second application file locator to the terminal;
when the instruction is a fourth instruction generated according to a first application file locator, the card returns a read record specified by the first application file locator to the terminal;
when the instruction is a fourth instruction generated according to a second application file locator, the card returns a read record specified by the second application file locator to the terminal.
that the value of application controller attribution of the card is a first preset value specifically is that the application controller attribution is: for any terminal, refuse business if fingerprint verifying is not successful;
that the value of application controller attribution of the card is a second preset value specifically is that the application controller attribution is: do not refuse business if the fingerprint verifying is not successful;
that the value of application controller attribution of the card is a third preset value specifically is that the application controller attribution is: for any terminal which is not a specified terminal, refuse business if the fingerprint is not successful.
Step 102 further comprising: when value of the application controller attribution of the card is a fourth preset value, executing Step 104.
that value of the application controller attribution of the card is a fourth preset value specifically is that application controller attribution is: do not supporting fingerprint verifying.

Step 101 further comprises: when the instruction is a fifth instruction comprising an application cryptogram request type, executing Step 106;
Step 106, the card obtains a card verifying result according to the fingerprint verifying result, generates a fifth instruction response according to the card verifying result, and returns the fifth instruction to the terminal.
generating a fifth instruction response according to the fingerprint verifying result of the card in Step 106 specifically is: generating, by the card, a fifth instruction response according to the card verifying result and the business refusing flag.
the card obtains a card verifying result according to the fingerprint verifying result in Step 106 specifically is that the card obtains a card verifying result according to the fingerprint verifying result and a result of determining whether fingerprint retry times surpasses limit.

Step 101 further includes: when the instruction is a first instruction comprising an application identifier of a specified application, the card returns a first instruction response comprising a specified application list.

Step 101 further includes: when the instruction is a second instruction including application identification of selecting application, the card returns a second instruction response including a Processing Options Data Object List.

That the card verifies fingerprint of a user, obtains a fingerprint verifying result in Step 102 specifically is: the card sends a waiting time extending instruction to the terminal at a preset time interval, verifies fingerprint of a user, stop to send the waiting time extending instruction to the terminal after the card obtaining a fingerprint verifying result.

### Embodiment 2

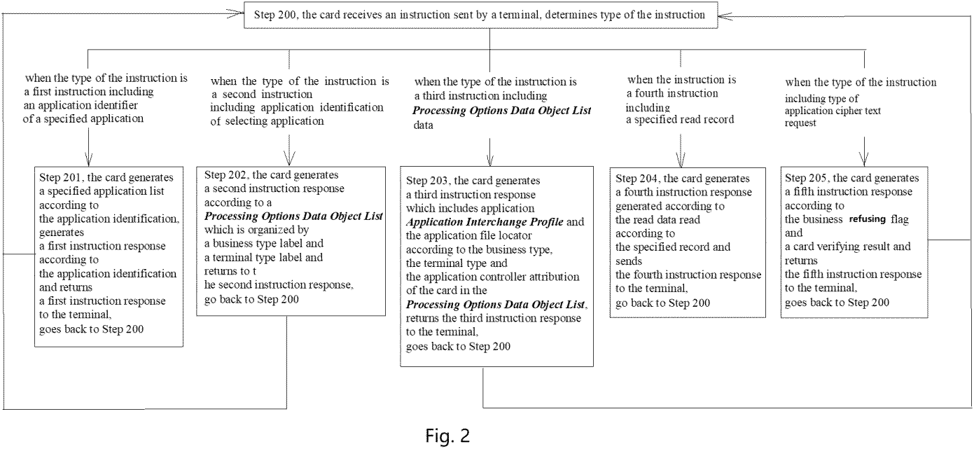

Embodiment 2 provides a method for realizing a fingerprint card. As shown in FIG. 2, the method comprises:
Step 200, the card receives an instruction sent by a terminal, determines type of the instruction, when the type of the instruction is a first instruction including an application identifier of a specified application, executing Step 201; when the type of the instruction is a second instruction including application identification of selecting application, executing Step 202; when the type of the instruction is a third instruction including Processing Options Data Object List data, executing Step 203; when the instruction is a fourth instruction including a specified read record, executing Step 204; when the type of the instruction including an application cryptogram request type, executing Step 205;
Step 201, the card generates a specified application list according to the application identification, generates a first instruction response according to the application identification and returns a first instruction response to the terminal, goes back to Step 200.
In Embodiment 2, the first instruction received by the card from the terminal is: 00A404000E 325041592E5359532 E4444463031.
Specifically, in the above instruction, 325041592E5359532E4444463031 specifies an identification of a specified application to be accessed, i.e., application of Proximity Payment Systems Environment (PPSE);
The card organizes a first instruction response according to a label of application identification of a specified application of the card, length of the application identification and the application identification.

Specifically, the first instruction response is:

6F23840E325041592E5359532E4444463031A511BF0C0E61 0C4F08
A000000151041010;

in this case, in the response data, data element 4F is label of the application identification, the value of the application identification is: A000000151 041010, specifically, A000000151041010 is the application identification of a specified application.

Step 202, the card generates a second instruction response according to a Processing Options Data Object List which is organized by a business type label and a terminal type label and returns to the second instruction response, go back to Step 200.

Specifically, in the present embodiment, the second instruction received by the card from the terminal is: 00A4040008 A000000151 041010; in this case, the application identification of the application selected by the terminal is: A000000151041010.

The card generates a second instruction response according to a Processing Options Data Object List which is organized according to attached terminal performance label and its specified length, label of business type and its specified length, label of terminal type and its specified length.

Specifically, the second instruction response of the card is:

6F3D8408A000000151041010A531500A4D6173746572436172649F3808
9F40059C019F3501BFOC179F5E095413339000001513019F5D030101009F4D0
20B0A;

in this case, Processing Options Data Object List is: 9F3808 9F4005 9C01 9F3501,
9F38 represents label of Processing Options Data Object List, its specified length is 8 bytes;
9F40 represents its attached terminal performance label, its specified length is 5 bytes;
9C represents business type label, its specified length is 1 byte;
9F35 represents terminal type label, its specified length is 1 byte.

Specifically, the attached terminal performance label, the business type label, the terminal type label in the Processing Options Data Object List respectively represent the attached terminal performance, the business type and the terminal type which are wanted by the card.

Step 203, the card generates a third instruction response which includes Application Interchange Profile and the application file locator according to the business type, the terminal type and the application controller attribution of the card in the Processing Options Data Object List, returns the third instruction response to the terminal, goes back to Step 200.

In the present embodiment 2, the third instruction received by the card from the terminal specifically is: 80A8000009 8307 1111000000 00 22, the domain of the third instruction is data requested by the Processing Options Data Object List of the second instruction response.

Specifically, the value of the attached terminal performance is: 1111000000;
the business type is: 00;
9F35 represents that terminal type is 22.

Specifically, the third instruction response includes Application Interchange Profile and application file locator.

Specifically, process of generating a third instruction response in Step 203 includes the following step:
the card determines an attribution of the application controller;
specifically, in the present step, the card determines value from the fifth bit to the seventh bit of the second byte of the application controller;
when the attribution of the application controller is: “not supporting fingerprint verifying”, the card returns obtaining processing option default response data.

Specifically, when the card determines that value from the fifth bit to the seventh bit of the second byte of the application controller is: 000 or 110 or 111, the card returns the third instruction response which the obtaining processing option default response data.

When the attribution of the application controller is: for any terminal, refusing business if fingerprint verifying is not successful, the following step is executed:
Specifically, when the card determines that the value of from the second byte to the fifth byte of the application controller is 011, following step is executed:
Step a1, the card verifies fingerprint input by a user, obtains a fingerprint verifying result and stores the fingerprint verifying result.

Step a1 specifically can be that the card sends a waiting time extending instruction to the terminal at a preset time interval and verifies fingerprint of a user at the same time, stops to send the waiting time extending instruction to the terminal after the card obtains and stores a fingerprint verifying result.

Step a2, the card determines whether the fingerprint verifying result is that fingerprint verifying is successful, if yes, executes Step a3, if no, sets a business refusing flag, executes Step a4.

Specifically, in the present step, the card determines value of byte in the data of the obtained fingerprint verifying result, if the value is 01, executes Step a3; if the value is 00 or 02, sets the business refusing flag, executes Step a4;

in this case, if the value of byte in the data of the obtained fingerprint verifying result is 01, it represents that fingerprint verifying is successful; if the value of byte in the data of the obtained fingerprint verifying result is 00, it represents that fingerprint verifying is not executed; if the value of byte in the data of the obtained fingerprint verifying result is 02, it represents that fingerprint verifying is failed.

Step a3, the card determines whether the business type is a specified business type, if yes, executes Step a4; if no, execute Step a5;

Specifically, in the present embodiment, the card determines whether the value of data of 9C which represents business type in the data of the Processing Options Data Object List is 01, 09 or 17, if yes, executes Step a4, if no, executes Step a5.

Step a4, the card returns a third instruction response which is obtaining processing option default response data.

Specifically, in the present Step a4, the third instruction response returned by the card is as the following:
the application interchange profile (AIP) is 7900;
the application file locator (AFL) is 08010100100104011801050020010301, in which
08010100 10010401 18010500 20010301 represent location to be read records and number of pieces to be read record.

Step a5, the card returns a third instruction response which is obtaining processing option fingerprint response data.

Specifically, in the present step, the card returns a third instruction response which is 771682026900941008010100100104 011801050020010301;
In this case, the Application Interchange Profile (AlP) is: 6900;
the application file locator (AFL) is 08010100100104011801050020010301, in which 08010100 100104 01 18010500 20010301 represent location to be read records and number of pieces to be read record. When the application controller attribution is: not refusing business if the fingerprint verifying is not successful, following steps are executed:

Specifically, when the card determines that value from the second bit to the fifth bit of the second byte of the application controller is: 001 or 010, the following steps are executed:

Step b1, the card verifies the fingerprint input by a user and obtains a fingerprint verifying result, stores the fingerprint verifying result.

Step b1 specifically can be that: the card sends a waiting time extending instruction to the terminal at a preset time interval and verifies fingerprint of a user at the same time, stops to send the waiting time extending instruction to the terminal after the card obtains a fingerprint verifying result and stores the fingerprint verifying result.

Step b2, the card determines whether the fingerprint verifying result is that fingerprint verifying is successful, if yes, executes Step b3; if no, executes Step b4;
Specifically, in the present step b2, the card determines value of the byte in the obtained fingerprint verifying result data, if the value is 01, executes Step b3, if the value is 00 or 02, execute Step b4;
in this case, if the value of byte in the data of the obtained fingerprint verifying result is 01, it represents that fingerprint verifying is successful; if the value of byte in the data of the obtained fingerprint verifying result is 00, it represents that fingerprint verifying is not executed; if the value of byte in the data of the obtained fingerprint verifying result is 02, it represents that fingerprint verifying is failed.

Step b3, the card determines whether the business type is a specified business type, if yes, executes Step b4, if no, executes Step b5.

Specifically, in the present embodiment 2, the card determines whether the value of data of 9C which represents business type in the data of the Processing Options Data Object List is 01, 09 or 17, if yes, executes Step b4, if no, executes Step b5. Step b4, the card returns a third instruction response which is obtaining processing option default response data.

Specifically, in the present step b4, the card returns a third instruction response, of which
the application interchange profile (AIP) is 7900;
the application file locator (AFL) is 08010100100104011801050020010301;
in this case, 08010100 10010401 18010500 20010301 represent location to be read records and number of pieces to be read record.

Step b5, the card returns a third instruction response which is obtaining processing option fingerprint response data.

Specifically, in the present step b5, the card returns a third instruction response which is 771682026900941008010100100104 011801050020010301;
in this case, the application interchange profile is: 6900;
the application file locator (AFL) is 08010100100104011801050020010301, of which 08010100 100104 01 18010500 20010301 represent location to be read records and number of pieces to be read record.

When the application controller attribution is: for any terminal which is not a specified terminal, refusing business if the fingerprint is not successful, the following steps are executed:
Specifically, in the present step b5, when the card determines that value from the fifth bit to the seventh bit of the second byte of the application controller is 100 or 101,
Step c0, the card determines whether the type of terminal is a specified type of terminal, if yes, executes Step c4; if no, executes Step c1.

Specifically, in the present step, the card determines whether the value of 9F35 which represents terminal type in the data of the Processing Options Data Object List is 14, 15 or 16 and the eighth bit of the first byte of the data corresponding to 9F40 which represents attached terminal performance is 1, if yes, execute Step c4, if no, execute Step c1.

Step c1, the card verifies fingerprint input by the user and obtains a fingerprint verifying result and stores the fingerprint verifying result;

Step c1, specifically can be that the card sends a waiting time extending instruction to the terminal at a preset time interval and verifies fingerprint of a user at the same time, stops to send the waiting time extending instruction to the terminal after the card obtains and stores a fingerprint verifying result.

Step c2, the card determines whether the fingerprint verifying result is that fingerprint verifying is successful, if yes, executes Step c3, if no, sets a business refusing flag, executes Step c4;
Specifically, the card determines value of byte of the obtained fingerprint verifying result, if the value is 01, executes Step c3, if the value is 00 or 02, executes Step c4;
in this case, if the value of byte in the data of the obtained fingerprint verifying result is 01, it represents that fingerprint verifying is successful; if the value of byte in the data of the obtained fingerprint verifying result is 00, it represents that fingerprint verifying is not executed; if the value of byte in the data of the obtained fingerprint verifying result is 02, it represents that the fingerprint verifying is failed.

Step c3, the card determines whether the business type is a specified business type, if yes, executes Step c4; if no, execute Step c5.

Specifically, in the present embodiment 2, the card determines whether the value of data of 9C which represents business type in the data of the Processing Options Data Object List is 01, 09 or 17, if yes, executes Step c4, if no, executes Step c5.

Step c4, the card returns a third instruction response which is obtaining processing option default response data.

Specifically, in the present Step c4, the third instruction response returned by the card is as the following:
the application interchange profile (AIP) is 7900;
the application file locator (AFL) is 08010100100104011801050020010301, in which
08010100 10010401 18010500 20010301 represents location to be read records and number of pieces to be read record.

Step c5, the card returns a third instruction response which is obtaining processing option fingerprint response data.

Specifically, in the present step, the card returns a third instruction response which is 771682026900941008010100100104 011801050020010301;
in this case, the Application Interchange Profile (AIP) is: 6900;
the application file locator (AFL) is 08010100100104011801050020010301, in which 08010100 100104 01 18010500 20010301 represents location to be read records and number of pieces to be read record.

Step 204, the card generates a fourth instruction response generated according to the read data read according to the specified record and sends the fourth instruction response to the terminal, go back to Step 200.

Specifically, in Embodiment 2, the card receives a fourth instruction, i.e., a read instruction, sent from the terminal, the read instruction includes a file of a specified record to be read.

Specifically, in the present step 204, that the card generates a fourth instruction response according to specified read record specifically is that the card read data according to a specified read record in the read instruction, generates a fourth instruction response according to the data read according to the specified read record.

Specifically, in Embodiment 2, the card generates a fourth instruction response which is:

9F6C0200019F62060000003800009F630600000000E0E05634423534313
33333393030303030313531335E202F5E32303132323031333330303033333330
3030323232323230303031313131309F6401039F6502000E9F66020E709F6B13
5413339000001513D20122019000990000000F9F6701035F24032012315F2503
0601019F0702FF005A0854133390000015139F0D05F8406420009F0E05001088
00009FOF05F86064F8005F280200568C279F02069F03069F1A0295055F2A029
A039C019F37049F35019F45029F4C089F34039F21039F7C148D12910A8A0295
059F37049F4C089F02069F03068E1400000000000000004201440341035E0342
031F039F420209789F0802000257125413339000001513D20122010000000000
009F5B0CDF6008DF6108DF6201DF63A09F51039F37049F3201038F01F49224
6E8042D075DDC54E51300D03E44EBFF7140C0556B39CA0D78B28553644A12
365F40FA5479081B0914315BDA0CCFC820718C0225A278C2964B9668C697A
4C00451 C75A10180B0BD3E2601 BDD30D3319DC4006E911 E271 B7C6AAEE28
FA65312BB1F680489CDC9CD311980E156F5841B7C6B0EFE3BD3DAA1C4D9
DE235644F461C79DF0336A8C570CA69BAC1EA1570C590178AAC7532934839
660F4C8F3B74023DBCD75E655240952AA1E4CB4ECF322749B51B72865B1 B2
8C1000E542E562FF20E0F9FCA28C930831F8FDC06FC7B05E162CB37570E41
C65D149F47030100019F482AAE83BF5BB436738AC650AC991DB606E56644E
9CCFC6A7035434D7D425C5FBF474799E09F79E31472FBF39F49039F37049F
2E030100019F2F2AC5C9852EDB8C522912F3D49EADDDEF2257297F73C995
5499297DD3386999A8BD86FEAB16F3191E15287B9F2D81B00302F0561066B
C392C611A317ADFA285DF7859CE7F58C84C98B9E5571606A5A7DC8D5FC57
8F6F5858BCC0A212C821A4CE05FED68BB9EB6B4368CEACDF913F5ADAD73
8EFA58B3C4849B811 DD53FE59DCC7353FACC2F3F407EE3F789F4D5AB7F65
27B075EE00C8AA1C6BCC6AF1AF9E789D2E38982653258940BC7D5A32F38B
2229183A8E585505B795F827BF5F8C4207A3890B90E68C98723302586581895
921B8E22941E87730515AA9F1E6C0C04E2F485F3401019381B08DF93EE206F
8F998F1919B44DDBE3F39337FCACCBFE9F48B7C29EDBF4F766CA0B53A67
235D70CCC580B4C166C9B3E3CDC3DCE06D36206AA42EC0BB71366EEA9F2
AC31387D138DF4553F7ADE93C4E6C8DAD181435111904A6A7F39A203291F6
32CF655A7C86FF7872F518F72F946012D3EA7E22F733E4F85CC1D8DB710A8
0E9E5423B6F83B56F0973121D5217D10E8668D21452834446850B26BA31506
B1BF994065B2E3CB5D956F5A8B0646BB232F60B0F4681B07896EECS5FCF7F1
BF73BD60455E20667B6A72EE9F625E6D97144A1BD0C4F589D271004EEC7D
ED670A5614F9F9D58D9B1827C3299F8775AC81B63C2DD76BC0AE94C23652
3F53309267F8F12DA0795F78CFC5F346DF0B16A110C55F4419FAAC363334E
7AEB3C5A2A0AA008D49AA139EDBAFB8AAS447E52F878F981126D866808E8
EB6B36D2B82440C47COED8D9DE0BB58B7C1D6E9D7C308EEF0BDB733E753
67231396F338BFFFD1D97B0759F32E719F9F02;

in this case, the specified read record includes a Card Risk Management Data Object List.

Specifically, the Card Risk Management Data Object List is:

8C279F02069F03069F1A0295055F2A029A039C019F37049F35019F4502
9F4C089F34039F21039F7C14.

Step 205, the card generates a fifth instruction response according to the business refusing flag and a card verifying result and returns the fifth instruction response to the terminal, then goes back to Step 200.

Specifically, in Embodiment 2, the fifth instruction is an application cipher text instruction sent by the terminal to the card, of which the domain of the application cipher text instruction is generated according to the Card Risk Management Data Object List.

Specifically, the cipher text instruction is

80AE4000420000000000010000000000000156000000000001562003310037151
A5F22000000000000000000003F000011314811111111111111111111111111111111
11111111.

The domain data of the application ciphertext instruction is parsed as the following: 9F02 represents authorized amount: 000000000001; 9F03 represents other amount: 000000000000; 9F1A represents terminal code 0156; 95 represents terminal verifying result: 0000000000; 5F2A represents business code: 0156; 9A represents date 200331; 9C represents business type: 00; 9F37 represents random number: 37151A5F; 9F35 represents terminal type: 22; 9F45 represents verification code of data: 0000; 9F4C represents ICC dynamic data: 0000000000000000; 9F34 represents card holder verifying method: 3F0000; 9F21 represents business time: 113148; 9F7C represents merchant custom data: 11111111111111111111111111 1111111111 1111.

Specifically, in the present step, the card generates a fifth instruction response data:

77319F2701409F360200019F2608C6E63C7578CDOA909F1 01A2210910
203240001000000000000000001FF00000000000000FF.

In this case, the card verifying result is 910203240001.

Specifically, in the present step, that the card generates a fifth instruction response specifically includes the following steps:

Step B1, the card generates a card verifying result.

Step B1 specifically is that the card sets value of byte in the card verifying result according to the fingerprint verifying result, which specifically includes the following steps:

Step d1, the card sets the value of the card verifying result according to the fingerprint verifying result and executing status of fingerprint verifying.

Specifically, the card sets the value of the first bit of the first byte of the card verifying result according to the card verifying result which represents success or failure and sets the value of the second bit of the card verifying result which represents whether executing or not.

Specifically, if the fingerprint verifying result is success, the value of the first bit of the first byte of the card verifying result is set to be 1; if the fingerprint verifying result is failure, the first bit of the first byte of the card verifying result is set to be 0; if the fingerprint verifying is executed, the value of the second bit of the second byte of the card verifying result is set to be 1; if the fingerprint verifying is not executed, the value of the second bit of the second byte of the card verifying result is set to be 0.

Step d2, the card sets value of the card verifying result according to a result obtained by determining whether fingerprint retry times surpasses limit or not.

Specifically, in the present step d2, the card sets the value of the first bit of the second byte of the card verifying result according to the a result that whether fingerprint retry times surpasses limit or not, if the card determines that the fingerprint retry times surpasses limit, the card sets the value of the first bit of the second byte of the card verifying result to be 1; if the card determines that the fingerprint retry times does not surpass limit, the card sets the value of the first bit of the second byte of the card verifying result to be 0.

Step B2, the card executes card behavior parsing and card risk managing to obtain a card behavior parsing result and a card risk managing result.

Step B3, the card generates an application cipher text instruction response according to the card behavior parsing result, a card risk managing result, cipher text request type in an application ciphertext instruction sent by the terminal, the business refusing flag of the card and the card verifying result.

In the present embodiment 2, the generated application cipher text instruction response can be an application cipher text response of refusing business, an application cipher text response of online business or an application cipher text response of offline business.

Specifically, in the present step B3, when the card determines that the business refusing flag is refusing flag, the card returns an application cipher text response of refusing business.

### Embodiment 3

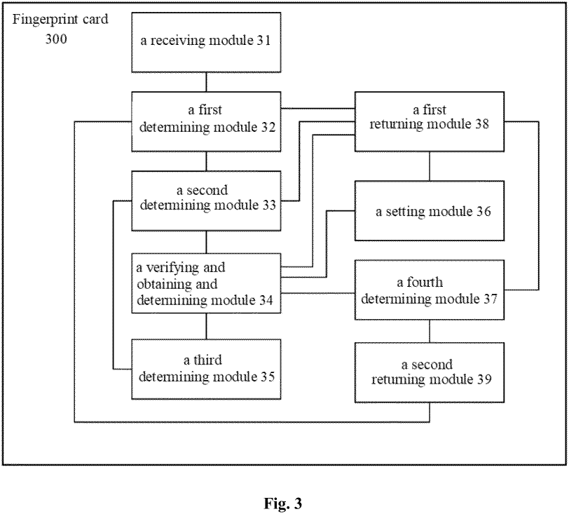

Embodiment 3 provides a fingerprint card 300, as shown in FIG. 3, the fingerprint card includes:
a receiving module 31 configured to receive an instruction sent from a terminal;
a first determining module 32 configured to determine type of the instruction received by the receiving module 31;
a second determining module 33 configured to determine value of application controller attribution of the card when the first determining module 32 determines that type of the instruction; when the instruction is a third instruction comprising Processing Options Data Object List data;
a verifying and obtaining and determining module 34 configured to verify fingerprint of a user, obtain a fingerprint verifying result and determine whether the fingerprint verifying result is that fingerprint verifying is successful when the second determining module 33 determines that the value of application controller attribution of the card is a first preset value;
the verifying and obtaining and determining module 34 further configured to verify fingerprint of a user, obtain a fingerprint verifying result and determine whether the fingerprint verifying result is that fingerprint verifying is successful when the second determining module 33 determines that the value of application controller attribution of the card is a second preset value;
the verifying and obtaining and determining module 34 further configured to verify fingerprint of a user, obtain a fingerprint verifying result and determine whether the fingerprint verifying result is that fingerprint verifying is successful when a third determining module 35 determines that type of the terminal is a specified terminal type;
the third determining module 35 configured to determine whether type of the terminal is a specified terminal type when the second determining module 33 determines that the value of the application controller attribution is a third preset value;
a setting module 36 configured to set business refusing flag when the second determining module 33 determines that the value of the application controller attribution is the first preset value and the verifying and obtaining and determining module 34 determines that the fingerprint verifying result is not that fingerprint verifying is successful;
the setting module 36 further configured to set business refusing flag when the third determining module 35 determines that the type of the terminal is not a specified terminal type and the verifying and obtaining and determining module 34 determines that the fingerprint verifying result is not that fingerprint verifying is successful;
a fourth determining module 37 configured to determine whether business type in the Processing Options Data Object List data is a specified type of business when the verifying and obtaining and determining module 34 determines that the fingerprint verifying result is that fingerprint verifying is successful;
a first returning module 38 configured to, after the setting module sets the business refusing flag, return a third instruction response of default type comprising a first Application Interchange Profile and a first application file locator to the terminal;
the first returning module 38 further configured to, when the fourth determining module 37 determines that business type in the Processing Options Data Object List data is specified type of business, return a third instruction response of fingerprint type comprising a second Application Interchange Profile and a second application file locator to the terminal;
the first returning module 38 further configured to return a third instruction response of default type comprising a first Application Interchange Profile and a first application file locator to the terminal when the second determining module 33 determines that the value of application controller attribution of the card is a second preset value and the verifying and obtaining and determining module 34 determines that the fingerprint verifying result is not that fingerprint verifying is successful; further configured to return a reading record specified by the first application file locator to the terminal when the first determining module 32 determines that the type of the instruction is a fourth instruction generated according to a first application file locator, and
a second returning module 39 configured to return a third instruction response of fingerprint type comprising a second Application Interchange Profile and a second application file locator to the terminal when the fourth determining module 37 determines that the business type in the Processing Options Data Object List data is not specified business type; further configured to return a reading record specified by the second application file locator to the terminal when the first determining module 32 determines that the type of the instruction is a fourth instruction generated according to the second application file locator.

In the Embodiment 3, that the second determining module 33 determines that the value of application controller attribution of the card is a first preset value specifically is that: the second determining module 33 determines that the application controller attribution of the card is: for any terminal, refuse business if fingerprint verifying is not successful;
that the second determining module 33 determines that the value of
application controller attribution of the card is a second preset value specifically is that: the second determining module 33 determines that the application controller attribution of the card is: do not refuse business if the fingerprint is not successful; and
that the second determining module 33 determines that the value of application controller attribution of the card is a third preset value specifically is that: the second determining module 33 determines that the application controller attribution of the card is: for any terminal which is not a specified terminal, refuse business if the fingerprint is not successful.

In the Embodiment 3, the first returning module 38 is further configured to a third instruction response of default type comprising a first Application Interchange Profile and a first application file locator to the terminal when the second determining module 33 determines that the value of application controller attribution of the card is a fourth preset value.

In the Embodiment 3, that the second determining module 33 determines that the value of application controller attribution of the card is a fourth preset value specifically is that: the second module determines that application controller attribution of the card is: do not support fingerprint verifying.

In the Embodiment 3, the fingerprint card further comprises: an obtaining and generating and returning module configured to, when the first determining module 32 determines that the instruction is a fifth instruction comprising an application cryptogram request type, a card verifying result according to the fingerprint verifying result, generate a fifth instruction response according to the card verifying result and return the fifth instruction to the terminal.

In the Embodiment 3, the obtaining and generating and returning module specifically is configured to, when the first determining module 32 determines that the instruction is a fifth instruction comprising application cryptogram request type, obtain a card verifying result according to the fingerprint verifying result, generate a fifth instruction response according to the card verifying result and the business refusing flag, return the fifth instruction response to the terminal.

In the Embodiment 3, the obtaining and generating and returning module specifically is configured to, when the first determining module 32 determines that the instruction is a fifth instruction comprising application cryptogram request type, obtain a card verifying result according to the fingerprint verifying result and a result of determining whether fingerprint retry times surpass limit, generate a fifth instruction response according to the card verifying result and the business refusing flag, return the fifth instruction response to the terminal.

In the Embodiment 3, the fingerprint card further includes a third returning module, configured to, when the first determining module 32 determines that the instruction comprising an application identifier of a specified application, return a first instruction response comprising a specified application list.

In the Embodiment 3, the fingerprint card further comprises a fourth returning module configured to, when the first determining module 32 determines that the instruction is a second instruction comprising an application identifier of selecting application, return a second instruction response comprising a Processing Options Data Object List.

In the Embodiment 3, the verifying and obtaining and determining module 34 is configured to verify fingerprint of the user, obtain a fingerprint verifying result specifically is: the verifying and obtaining and determining module 34 configured to send a waiting time extending instruction to the terminal at a preset time interval, verify fingerprint of a user, stop to send the waiting time extending instruction to the terminal after the card obtaining a fingerprint verifying result.

The embodiments of the invention will be further described in details as below. Examples of the embodiments are shown in drawings. Apparently, the disclosures are only a few specific embodiments of the application, but the application is not limited to them, and any changes that can be thought of by those skilled in the art should fall into the protection scope of the application. The protection scope of the application is approved by the protection scope of the claims.

1. A method for realizing a fingerprint card, comprising the following steps:
1) receiving, by a card, an instruction sent by a terminal, and determining a type of the instruction; when the instruction is a third instruction comprising Processing Options Data Object List data, executing Step 2;
2) determining, by the card, a value of an application controller attribution of the card,
when the value of application controller attribution of the card is a first preset value, verifying, by the card, a fingerprint of a user, obtaining a result of fingerprint verifying and determining whether the result of fingerprint verifying is that fingerprint verifying is successful, if yes, executing Step 3, if no, setting, by the card, a business refusing flag, then executing Step 4;
when the value of the application controller attribution is a second preset value, verifying, by the card, the fingerprint of the user, obtaining a fingerprint verifying result and determining whether the fingerprint verifying result is that fingerprint verifying is successful, if yes, executing Step 3; otherwise, executing Step 4; and
when the value of the application controller attribution is a third preset value, determining, by the card, whether the type of the terminal is a specified terminal type, if yes, executing Step 4; if no, verifying, by the card, the fingerprint of the user, obtaining a fingerprint verifying result and determining whether the fingerprint verifying result is that fingerprint verifying is successful, if yes, executing Step 3, if no, setting, by the card, a business refusing flag, then executing Step 4;
3) determining, by the card, whether a business type in the Processing Options Data Object List data is a specified type of business, if yes, executing Step 4; if no, executing Step 5;
4) returning, by the card, a third instruction response of a default type comprising a first Application Interchange Profile and a first application file locator to the terminal;
5) returning, by the card, a third instruction response of a fingerprint type comprising a second Application Interchange Profile and a second application file locator to the terminal;
when the instruction is a fourth instruction generated according to the first application file locator, returning, by the card, a read record specified by the first application file locator to the terminal; and
when the instruction is a fourth instruction generated according to the second application file locator, returning, by the card, a read record specified by the second application file locator to the terminal.

2. The method of claim 1, wherein
that the value of an application controller attribution of the card is a first preset value specifically is that the application controller attribution is: “for any terminal, refuse business if the fingerprint verifying is not successful”;
that the value of an application controller attribution of the card is a second preset value specifically is that the application controller attribution is: “do not refuse business if the fingerprint verifying is not successful”; and
that the value of an application controller attribution of the card is a third preset value specifically is that the application controller attribution is: “for any terminal which is not a specified terminal, refuse business if the fingerprint is not successful”.

3. The method of claim 1, wherein Step 2 further comprises: when the value of the application controller attribution of the card is a fourth preset value, executing Step 4.

4. The method of claim 3, wherein that the value of the application controller attribution of the card is a fourth preset value specifically is that the application controller attribution is: “do not support fingerprint verifying”.

5. The method of claim 1, wherein Step 1 further comprises: when the instruction is a fifth instruction comprising an application cryptogram request type, executing the following Step 6;
6) obtaining, by the card, a card verifying result according to the fingerprint verifying result, generating a fifth instruction response according to the card verifying result, and returning the fifth instruction to the terminal.

6. The method of claim 5, wherein generating a fifth instruction response according to the fingerprint verifying result of the card in Step 6 specifically is:
generating, by the card, a fifth instruction response for refusing a business according to the card verifying result and the business refusing flag.

7. The method of claim 5, wherein obtaining, by the card, a card verifying result according to the fingerprint verifying result in Step 6 specifically is: obtaining, by the card, a card verifying result according to the fingerprint verifying result and a result of determining whether fingerprint retrying times surpasses limit.

8. The method of claim 1, wherein Step 1 further comprises: when the instruction is a first instruction comprising an application identifier of a specified application, returning, by the card, a first instruction response comprising a specified application list.

9. The method of claim 1, wherein Step 1 further comprises: when the instruction is a second instruction comprising an application identification of a selecting application, returning a second instruction response comprising a Processing Options Data Object List to the terminal.

10. The method of claim 1, wherein verifying, by the card, a fingerprint of a user, obtaining a fingerprint verifying result in Step 2 specifically is: sending, by the card, a waiting time extending instruction to the terminal at a preset time interval, and verifying the fingerprint of a user at the same time, stopping to send the waiting time extending instruction to the terminal after the card obtaining the fingerprint verifying result.

11. A fingerprint card, wherein said fingerprint card comprises:
a receiving module configured to receive an instruction sent from a terminal;
a first determining module configured to determine a type of the instruction received by the receiving module;
a second determining module configured to determine a value of an application controller attribution of the card when the first determining module determines that the type of the instruction is a third instruction comprising Processing Options Data Object List data;
a verifying and obtaining and determining module configured to verify a fingerprint of a user, obtain a fingerprint verifying result, and determine whether the fingerprint verifying result is that the fingerprint verifying is successful when the second determining module determines that the value of the application controller attribution of the card is a first preset value;
the verifying and obtaining and determining module further configured to verify a fingerprint of a user, obtain a fingerprint verifying result and determine whether the fingerprint verifying result is that the fingerprint verifying is successful when the second determining module determines that the value of the application controller attribution of the card is a second preset value;
the verifying and obtaining and determining module further configured to verify a fingerprint of a user, obtain a fingerprint verifying result and determine whether the fingerprint verifying result is that the fingerprint verifying is successful when a third determining module determines that the type of the terminal is a specified terminal type;
the third determining module configured to determine whether the type of the terminal is a specified terminal type when the second determining module determines that the value of the application controller attribution is a third preset value;
a setting module configured to set a business refusing flag when the second determining module determines that the value of the application controller attribution is the first preset value and the verifying and obtaining and determining module determines that the fingerprint verifying result is not that fingerprint verifying is successful;
the setting module further configured to set a business refusing flag when the third determining module determines that the type of the terminal is not a specified terminal type and the verifying and obtaining and determining module determines that the fingerprint verifying result is not that fingerprint verifying is successful;
a fourth determining module configured to determine whether a business type in the Processing Options Data Object List data is a specified type of business when the verifying and obtaining and determining module determines that the fingerprint verifying result is that fingerprint verifying is successful;
a first returning module configured to, after the setting module sets the business refusing flag, return a third instruction response of a default type comprising a first Application Interchange Profile and a first application file locator to the terminal;
the first returning module further configured to, when the fourth determining module determines that the business type in the Processing Options Data Object List data is a specified type of business, return a third instruction response of a fingerprint type comprising a first Application Interchange Profile and a first application file locator to the terminal;
the first returning module further configured to return a third instruction response of a default type comprising a first Application Interchange Profile and a first application file locator to the terminal when the second determining module determines that the value of the application controller attribution of the card is a second preset value and the verifying and obtaining and determining module determines that the fingerprint verifying result is not that the fingerprint verifying is successful;
the first returning module further configured to return a reading record specified by the first application file locator to the terminal when the first determining module determines that the type of the instruction is a fourth instruction generated according to a first application file locator, and
a second returning module configured to return a third instruction response of a fingerprint type comprising a second Application Interchange Profile and a second application file locator to the terminal when the fourth determining module determines that the business type in the Processing Options Data Object List data is not a specified business type; and further configured to return a reading record specified by the second application file locator to the terminal when the first determining module determines that the type of the instruction is a fourth instruction generated according to the second application file locator.

12. The fingerprint card of claim 11, wherein
that the second determining module determines that the value of the application controller attribution of the card is a first preset value specifically is that the second determining module determines that the application controller attribution of the card is: for any terminal, refuse business is done if the fingerprint verifying is not successful;
that the second determining module determines that the value of the application controller attribution of the card is a second preset value specifically is that the second determining module determines that the application controller attribution of the card is: do not refuse business if the fingerprint is not successful; and
that the second determining module determines that the value of the application controller attribution of the card is a third preset value specifically is that the second determining module determines that the application controller attribution of the card is: for any terminal which is not a specified terminal, refuse business if the fingerprint is not successful.

13. The fingerprint card of claim 11, wherein the first returning module is further configured to return a third instruction response of a default type comprising a first Application Interchange Profile and a first application file locator to the terminal when the second determining module determines that the value of the application controller attribution of the card is a fourth preset value.

14. The fingerprint card of claim 13, wherein that the second determining module determines that the value of the application controller attribution of the card is a fourth preset value specifically is that the second module determines that the application controller attribution of the card is: do not support fingerprint verifying.

15. The fingerprint card of claim 11, wherein the fingerprint card further comprises: an obtaining and generating and returning module configured to, when the first determining module determines that the instruction is a fifth instruction comprising an application cryptogram request type, obtain a card verifying result according to the fingerprint verifying result, generate a fifth instruction response according to the card verifying result, and return the fifth instruction to the terminal.

16. The fingerprint card of claim 15, wherein the obtaining and generating and returning module specifically is configured to, when the first determining module determines that the instruction is a fifth instruction comprising the application cryptogram request type, obtain a card verifying result according to the fingerprint verifying result, generate a fifth instruction response according to the card verifying result and the business refusing flag, and return the fifth instruction response to the terminal.

17. The fingerprint card of claim 15, wherein the obtaining and generating and returning module specifically is configured to, when the first determining module determines that the instruction is a fifth instruction comprising the application cryptogram request type, obtain a card verifying result according to the fingerprint verifying result and result of determining whether fingerprint retrying times surpasses limit, generate a fifth instruction response according to the card verifying result and the business refusing flag, and return the fifth instruction response to the terminal.

18. The fingerprint card of claim 11, wherein the fingerprint card further comprises a third returning module configured to, when the first determining module determines that the instruction comprising an application identifier of a specified application, return a first instruction response comprising a specified application list to the terminal.

19. The fingerprint card of claim 11, wherein the fingerprint card further comprises a fourth returning module configured to, when the first determining module determines that the instruction is a second instruction comprising an application identifier of selecting application, return a second instruction response comprising a Processing Options Data Object List to the terminal.

20. The fingerprint card of claim 11, wherein the verifying and obtaining and determining module is configured to verify fingerprint of the user, and obtain a fingerprint verifying result specifically is the verifying and obtaining and determining module configured to send a waiting time extending instruction to the terminal at a preset time interval, verify a fingerprint of a user at the same time, and make the card stop to send the waiting time extending instruction to the terminal after the card obtaining a fingerprint verifying result.
